(19) United States
(12) Patent Application Publication
(10) Pub. No.: US 2019/0159639 A1
(43) Pub. Date: May 30, 2019

(54) TRANSMISSION ARRANGEMENT AND METHOD FOR USING A DEVICE MOVED BY A HYDRAULIC CYLINDER

(71) Applicant: HIGH GIENIC OY, Piispanristi (FI)

(72) Inventors: Juha LAHTIVUORI, Littoinen (FI); Jari KASKELIN, Tammela (FI)

(21) Appl. No.: 16/098,349

(22) PCT Filed: May 2, 2017
(86) PCT No.: PCT/FI2017/050339

§ 371 Date: Nov. 1, 2018

(30) Foreign Application Priority Data
May 2, 2016 (FI) 20165377

(51) Int. Cl. A47K 13/10; E05F 15/53

(52) U.S. Cl. CPC A47K 13/10; F04B 49/06; E05F 15/53

(57) ABSTRACT

The object of the invention is a transmission arrangement for a moveable device, such as a door (1) opening mechanism (2) and a method for using a device moved with a hydraulic cylinder (3). The method comprises at least the following steps:
producing a signal for moving the device (1) in a first or second direction and sending the signal to the control device,
if the signal was a signal to move the device (1) in the first direction, the first pump (11, 12) is started by means of a signal from the control device, and the pump produces fluid pressure on the first side of the hydraulic cylinder (3) in order to move the device (1) in the first direction,
if the signal was a signal to move the device (1) in the second direction, the second pump (13, 14) is started by means of a signal from the control device, and the pump produces fluid pressure on the second side of the hydraulic cylinder (3) in order to move the device (1) in the second direction,
monitoring the movement and/or position of the device with a sensor (18), which sends information to the control device about the position and/or movement of the device (1),
making a decision in the control device about the necessary procedure,
starting or stopping the first pump (11, 12) and/or the second pump (13, 14) with the aid of a signal from the control device based on the made decision.

Fluid pressure is produced with centrifugal pumps used with electric motors.

### TECHNICAL FIELD OF THE INVENTION

The invention relates to a transmission arrangement and method for using a device moved by a hydraulic cylinder as presented in the preambles of the independent claims presented below and different embodiments thereof. The invention especially relates to a novel manner of controlling and using a device moved by a hydraulic cylinder, such as a door that can be opened and closed.

### PRIOR ART

Easy service, durability against vandalism and automation is required of moving devices, such as automatic doors, especially in public spaces. Automation guides the user and performs functions on behalf of the user. The role of automation and technology has greatly increased, devices have become more complicated and devices are more expensive.

Doors that open automatically, i.e. by machine power, usually work with an electric motor, a pneumatic cylinder or a hydraulic cylinder. The opening system of an electric door is usually inexpensive and easy to install. The electric motor or automation that controls it can however easily break, for example when the door is opened manually against the intended movement direction of the door.

Use of doors using hydraulics at a bigger scale has been sparse due to high manufacturing costs. Door opening and closing mechanisms utilizing hydraulics are used for example in watertight doors in ships. They use a high hydraulic pressure, for example a pressure of over 10 bars. Devices functioning in high pressure, such as necessary valves, pipes and connectors, must be made very durable, for example from stainless steel. The necessary solutions are often quite complex.

Train doors for example utilize pneumatically functioning opening systems, which are loud and require a lot of room for the technology. Their safe use also requires demanding safety devices, because the produced compressed air does not typically transfer power directly. Typically when using compressed air, a sufficient pressure is first collected, which then pushes aside a rolling resistance. Thus the movements of the door become rather imprecise.

The force of doors functioning by machine power must usually for safety reasons be limited, often with expensive but still unsecure solutions.

The fast and powerful movements of the motorized door may cause structural damages to the door, its opening mechanism or the structures the door is attached to.

The sudden and loud function of the door causes a fear of motorized doors or automatic doors in some users.

The above-mentioned problems regarding doors are typical also for other moveable devices. For example automatic toilets have a need for moving actuators, the use of which is easy, safe and reliable.

### Object of the Invention

The object of the present invention is to reduce or even eliminate the above-mentioned problems appearing in prior art.

An object of the present invention is to achieve a transmission arrangement for a moving device, such as a door opening mechanism, the construction of which is less expensive, simpler and faster, and which has a better reliability than previous solutions.

An object of the present invention is to achieve a transmission arrangement, such as a door opening mechanism, which is more durable against vandalism, especially for public spaces.

An object of the present invention is to achieve a transmission arrangement, such as a door opening mechanism, the post-installation of which into existing doors is easy.

An object of the present invention is to achieve a safe moveable device, such as an automatic door or an actuator of an automatic toilet, for example for public spaces.

### BRIEF DESCRIPTION OF THE INVENTION

In order to realize among other the above-mentioned objects the transmission arrangement and method and their embodiments according to the invention, such as a door opening mechanism, a door, a moving seat of an automatic toilet, a seat module of an automatic toilet, an automatic toilet and other objects of the invention are characterized in what is presented in the characterizing parts of the attached independent claims.

The embodiments and advantages mentioned in this text relate, where applicable, to all objects of the invention, even if this is not always specifically mentioned.

A door in this text means a door, a hatch, a lid or another closing device of an opening, which can be opened and closed. A door can be opened for example sideways, downwards or upwards. The door can be a sliding door. The door or other moveable device can be hinged, to turn for example around a horizontal or vertical axis. The technology is suitable for opening large or heavy, but also small and light devices, such as doors, hatches and lids. The force required for moving the device, such as for opening the door, can for example be less than 500 N or less than 300 N. The device, such as the door, can be equipped with a counterweight, which assists in moving the device.

A typical transmission arrangement according to the invention for moving a device comprises at least the following
a hydraulic cylinder, which can be connected to a moveable device in order to move it,
a first pump, which is connected via a liquid connection to the first side of the hydraulic cylinder, for achieving movement of the device in a first direction,
a second pump, which is connected via a liquid connection to the second side of the hydraulic cylinder, for achieving movement of the device in a second direction,
a control device for using the first and/or second pump,
   which first and second pump are centrifugal pumps used with an electric motor.

The transmission arrangement further comprises at least one
sensor, for example a Hall sensor, which can be arranged to monitor the movement of the device and is connected to the control device for transferring a signal produced by a detected movement to the control device.

For example, if the moveable device is a door, the embodiment of the invention can be a door opening mechanism, which comprises at least the following
a hydraulic cylinder, which can be connected to a door that can be opened in order to open and close it,
a first pump, which is connected via a liquid connection to the first side of the hydraulic cylinder, for achieving a closing movement of the door,
a second pump, which is connected via a liquid connection to the second side of the hydraulic cylinder, for achieving an opening movement of the door.

A typical method according to the invention for using a device moved by a hydraulic cylinder, such as a door than can be opened and closed, comprises at least the following steps
producing a signal for moving the device in a first or second direction, such as a door opening signal or a door closing signal, and sending it to the control device;
if the signal was a signal to move the device in the first direction, the first pump is started by means of a signal from the control device, and the pump produces fluid pressure on the first side of the hydraulic cylinder in order to move the device in the first direction. For example, if the signal was a door closing signal, the first pump is started by means of a signal from the control device in order to achieve a closing movement of the door;
if the signal was a signal for the device to move in the second direction, the second pump is started by means of a signal from the control device, and the pump produces fluid pressure on the second side of the hydraulic cylinder in order to move the device in the second direction. For example, if the signal was a door opening signal, the second pump is started by means of a signal from the control device in order to achieve an opening movement of the door.

Fluid pressure is produced with centrifugal pumps used with electric motors.

A typical method according to the invention further comprises the following steps
monitoring the movement of the device with a sensor, for example a Hall sensor, which sends information to the control device about the position and/or movement of the device,
making a decision in the control device about the necessary procedure,
starting or stopping the first pump and/or second pump based on the made decision with the aid of the signal from the control device.

Now it has thus been found that the transmission arrangement of a device moved by a hydraulic cylinder, such as a door opening mechanism, can be arranged to be used with a centrifugal pump. They are not usually used in hydraulics due to their typically weak pressure output. As pump types, they are however simple and thus inexpensive and reliable.

With a centrifugal pump the back current of the liquid can be let to pass nearly unhindered through the pump. Typically this is seen as a drawback, but now it has surprisingly been found that for example in a door opening mechanism, this is an advantage. The back current makes it possible that the first and second pump pumping in different directions and the hydraulic cylinder are in liquid connection at all times. One embodiment can for example entail that when the first pump is on, the second pump is turned off, and vice versa. The hydraulic fluid can pass through the non-operational pump as a back current. The invention thus does not require special valve arrangements or other complicated solutions for arranging liquid flow occurring in different directions.

In the arrangement according to the invention, there is no need to maintain a constant pressure. In the solution according to the invention, the liquid pipe system can be arranged to be practically pressure-free in its resting state. In other words, when the first and/or second pump is not pumping, the liquid to be pumped is kept mainly pressure-free. With the aid of the invention, the fluid pressure can be kept remarkably low even during use of the pump.

Large losses due to leaks are not likely to happen in a system kept at a low pressure. If the system is pressure-free when not in use, leaks are unlikely also in the long run.

Lower fluid pressure than in traditional hydraulics systems is a safe solution and it makes possible using simpler and less expensive structures and components. For example joints and pressure hoses do not need to be dimensioned with a high, not to mention a continuously high pressure in mind. In one embodiment of the invention, the liquid connections are partly or completely made of plastic piping. A centrifugal pump suitable for the invention is less expensive than corresponding pumps producing high pressure. A suitable centrifugal pump is typically less expensive than a single pneumatic magnet valve.

In the solution according to the invention the pumps can be placed close to the object of use. Thus the liquid connections become short, and a pressurized network, which is often necessary, is not needed at all.

Movement of a door or another moveable device produced with centrifugal pumps producing low fluid pressure is soft and soundless. Smooth movements reduce stresses on the structures and thus service need.

The invention makes it possible that a pressure accumulator normally needed in corresponding systems is not needed at all. The centrifugal pump can raise the hydraulic pressure quickly enough in several different objects of use. For example in a traditional system realized with pneumatics, the compressor pump must run for quite a long time before a sufficient work pressure is achieved in the network.

In the solution according to the invention the energy consumption is remarkably smaller than in a pneumatic system with a corresponding effect. The speed of the moveable device is easy to change by changing the current of the electric motor.

The transmission arrangement according to the invention, for example the door opening mechanism, comprises a sensor, for example a Hall sensor, which can be arranged to monitor the movement of the moveable device, such as the door, and is connected to the control device in order to transfer the signal produced by the detected movement to the control device. In an embodiment of the invention
the movement and/or position of the door or other device is monitored with a sensor, for example a Hall sensor, which sends information to the control device about the position and/or movement of the door or other device,
a decision is made in the control device about the necessary procedure,
the first pump and/or second pump is started or stopped based on the made decision with the aid of the signal from the control device.

Monitoring the movement of the door or other device makes it possible for example to notice obstructions between or in front of the door or other device. Thus the interrupted closing of the door can for example be stopped or the movement can be changed to open. In an embodiment of the invention
if the control device finds that the movement of the door or other device has stopped in the middle of its movement, such as the door opening movement or closing movement, the first pump and/or second pump is stopped.

In one embodiment of the invention the transmission arrangement, for example the door opening mechanism, comprises an approach switch, such as a motion detector, which can be arranged to detect movement of a user near the door or other device and which is connected to the control device in order to transfer the signal produced by the detected movement of the user to the control device. In an embodiment of the invention
the movement of a user near the device, such as the door, is detected with an approach switch, which sends to the control device the signal produced by the detected movement of the user,
a decision is made in the control device about a necessary procedure,
the first pump and/or second pump is started or stopped based on the made decision with the aid of a signal from the control device.

Such a device, such as a door, can for example be programmed to open automatically when a user approaches it.

In one embodiment of the invention the transmission arrangement, for example the door opening mechanism, comprises a hydraulic fluid container, which is connected via a liquid connection to the hydraulic cylinder and the first pump and the second pump. In one embodiment of the invention the first pump, the second pump and the hydraulic cylinder are together in the same closed fluid circulation. In one embodiment of the invention the suction connections of the pumps are connected to two branches of a T-joint and the third branch is connected to the bottom of the same hydraulic fluid container. A T-branch does not need valves or the like, but it can be a completely open pipe. In one embodiment of the invention the outlet connections of the pumps are connected with hoses to the inlet connections of the hydraulic cylinder, on different sides of the hydraulic cylinder. Such arrangements are very simple and reliable.

The door according to the invention comprises a door opening mechanism according to the invention connected thereto.

The door according to the invention can be installed in a public space commode or an automatic toilet, which has a door meant for the toilet user, the use energy needed for the movement of the opening mechanism of which is produced with the opening mechanism according to the invention.

One embodiment of the invention is a method for retrofitting the door opening mechanism, which comprises at least the following steps
removing unnecessary parts of the old opening mechanism,
installing a new door opening mechanism according to the invention between the door and the door frame or other support part.

The invention makes possible a very quick and simple retrofitting. The hydraulic cylinder is connected between the door and for example the door frame. The entire rest of the apparatus can be placed in one compact part, for example a case or box, from which emerge at a minimum only an electric connection and possibly a hydraulic fluid feeding connection for adding fluid.

The invention can be used in public space doors. A public space means for example parks, subway, service and train stations or the like, often unsupervised places.

The invention is well suited for use in public space commodes, for example in the commode door. The invention can be realized as a part of an automatic toilet. An automatic toilet means that the toilet can be equipped for example with automatic raising and/or lowering of the toilet seat, automatic flushing of the toilet bowl, automatically rising and/or sinking support handles, a hand dryer integrated into the structure, an electric toilet bowl flushing container integrated into the structure, a cleaning hose and an electric automation unit controlling the functions. The automation unit can also control the opening and/or closing of the commode door, lighting inside and outside the commode, electric locking of the door, the occupied/free light and automatic floor washing. Automatic toilets and many of their properties are as such prior art and all of their properties are not discussed in this text.

The moveable seat of an automatic toilet according to the invention comprises a transmission arrangement according to the invention, which is arranged to move the seat.

The seat module of an automatic toilet according to the invention comprises a frame and a toilet actuator attached thereto in a moveable manner. The seat module comprises a transmission arrangement according to the invention, which is arranged to move the actuator. The moveable actuator can for example be an automatically moving seat or washing device.

The automatically moving washing device can for example comprise a shaft attached in a moveable manner to the frame of the automatic toilet's seat module and a washing unit attached to the shaft. The washing unit can for example have means for steering water and/or detergent onto the seat, into the toilet bowl and/or onto another part of the toilet meant to be washed. The washing unit can also comprise a dryer, for example means for steering drying air onto the seat or other part of the toilet to be dried.

The invention can comprise an electric control unit, with the aid of which the movement of the moveable device is controlled, such as the function of the door opening mechanism and possible other technology required by the object of use, such as the automatic toilet or commode. The electric control unit can comprise a computer, which has a memory and a program and its program code elements stored in the memory for performing the control functions. The control unit can comprise a user interface or it can be used remotely for example via a mobile device's screen. The control unit can comprise the necessary telecommunications means for receiving measurement data from possible sensors, such as the door's and moving actuators' motion detectors and limit switches. The control unit can comprise the necessary telecommunications means for delivering control commands to different actuators. For example in an automatic toilet such actuators can be transmission means, which cause the movements and functions of the toilet seat, support handles, toilet bowl flushing, hand dryer and outer door. The control technology and function and structure of the control unit, computers and telecommunications are as such prior art, and not particularly the object of this invention, so they are not explained further in this text.

It is possible to arrange the transmission arrangement comprising two centrifugal pumps, a hydraulic cylinder, and an at least mainly closed liquid circulation between them, to move also other devices than doors, seats or washing devices, for example other devices that can be opened and closed or other moveable devices. The invention is suitable for many different solutions functioning with a linear movement produced by a hydraulic cylinder. The invention is for example suitable for opening and closing service hatches, fire hatches, ventilation hatches in greenhouses and other hatches. The invention is excellently suited for moving an automatic toilet's seat.

The washing device of the automatic toilet described in the text with its possible shaft can be moved also with something other than the hydraulic system according to the invention, for example one or more electric motors.

### BRIEF DESCRIPTION OF THE FIGURES

The invention is described in more detail below with reference to the enclosed schematic drawing, in which

FIG. 1 shows a door according to the invention from the front,

FIG. 2 shows section W-W of FIG. 1,

FIG. 3 shows a door according to the invention from the back and partly opened,

FIG. 4 shows section R-R of FIG. 1,

FIG. 5 shows detail U of FIG. 3 as an enlargement,

FIG. 6 shows detail X of FIG. 2 as an enlargement,

FIG. 7 shows an opening mechanism of the door according to the invention seen from above,

FIG. 8 shows the opening mechanism of FIG. 7 from the front, and

FIG. 9 shows a seat module of the automatic toilet according to the invention.

### DETAILED DESCRIPTION OF THE EXAMPLES OF THE FIGURES

Sometimes the same reference numbers are for the sake of clarity used for corresponding parts in different figures and embodiments.

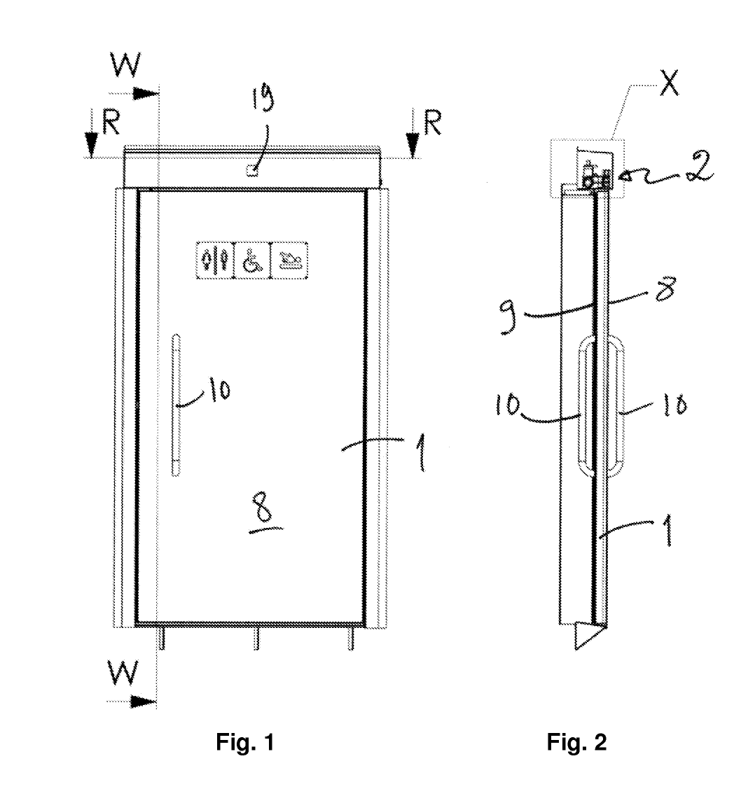

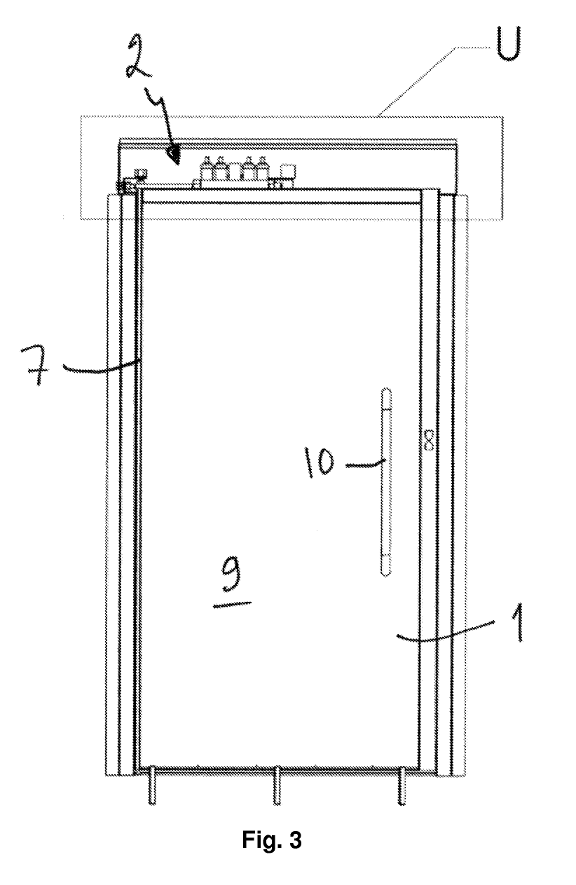

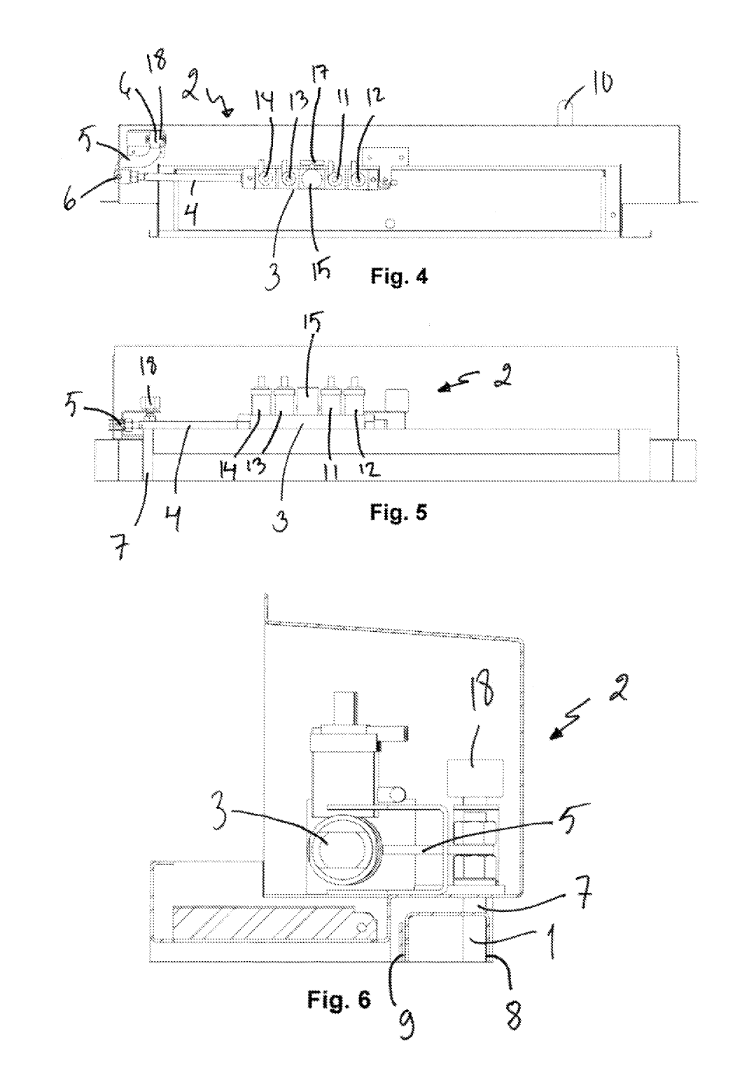

FIGS. 1-6 show an automatic toilet's door 1, to which an opening mechanism 2 according to the invention has been connected. The door opening mechanism comprises a hydraulic cylinder 3, the piston rod 4 of which is connected in a prior art manner via an opening shaft 5 and joints 6 to a vertical axis pole 7 of a door hinge. The movement of the piston rod 4 of the cylinder is thus arranged to open and close the door 1. The front surface 8 of the door is meant to be toward the outside and a toilet sign has been attached thereto. The rear surface 9 of the door is meant to be toward the inside of the toilet. Both sides of the door have a handle 10.

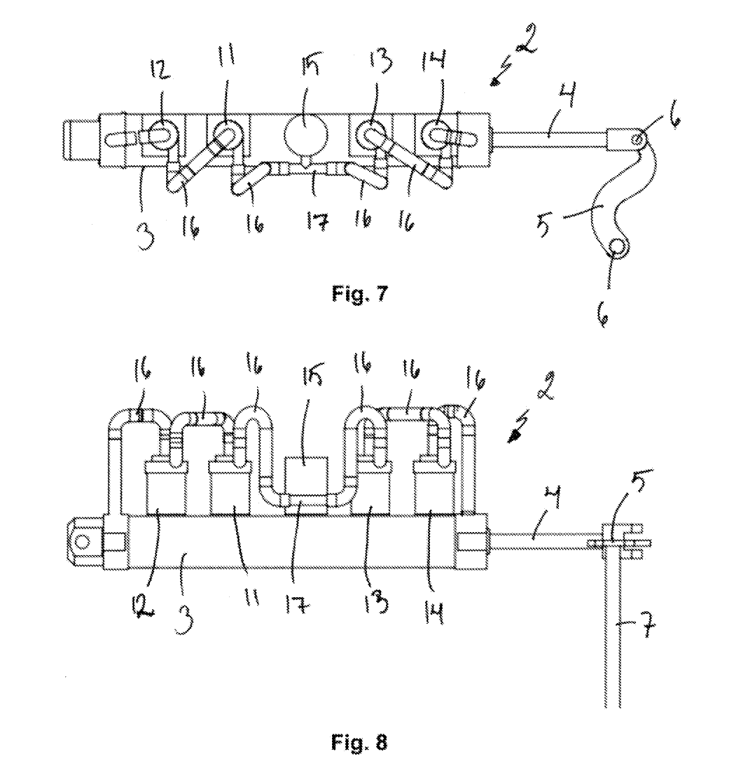

The opening mechanism 2 comprises four electrically driven centrifugal pumps 11, 12, 13 and 14 and a hydraulic fluid container 15. The pumps, the hydraulic fluid container and the cylinder 3 are connected into liquid connection via plastic pipes 16. For the sake of clarity, the plastic pipes are drawn to be visible only in FIGS. 7 and 8.

It is worth noting that in the examples of FIGS. 7 and 8 the opening mechanism is drawn the other way around than in FIGS. 1-6, i.e. the piston rod 4 of the hydraulic cylinder 3 and the vertical axis pole 7 of the door hinge are on the right in FIGS. 7 and 8.

FIGS. 7 and 8 show how the opening and closing pumps, the hydraulic cylinder and the hydraulic fluid container are in the same closed fluid circulation together. From the hydraulic fluid container 15 a fluid pipe branches out in a T-branch toward the closing pumps 11 and 12 and toward the opening pumps 13 and 14. The first fluid pipes lead from the T-branch 17 to the suction connection of the pump 11, out from the outlet connection of the pump 11 and from there to the suction connection of the pump 12, out from the outlet connection of the pump 12 and from there to the inlet of the first chamber of the hydraulic cylinder. The second fluid pipes lead from the T-branch 17 to the suction connection of the pump 13, out from the outlet connection of the pump 13 and from there to the suction connection of the pump 14, out from the outlet connection of the pump 14 and from there to the inlet of the second chamber of the hydraulic cylinder.

The function of the hydraulic cylinders is as such prior art. Thus the first and second chambers of the hydraulic cylinder are for example not shown separately in the figures. The first chamber of the hydraulic cylinder means the chamber, where the supplied fluid pressure causes the piston rod 4 to protrude out from the hydraulic cylinder 3, i.e. causes the door closing movement in the examples of the figure. For example in the situation in the figures, the piston rod 4 is protruded and the toilet door 1 is thus closed. The second chamber of the hydraulic cylinder means the chamber, where the supplied fluid pressure causes the piston rod 4 to retract into the hydraulic cylinder 3, i.e. causes the door opening movement in the examples of the figure.

The closing pumps 11 and 12 are connected into a series with each other, so that when running, both produce a liquid flow in the same direction. In the same way, the opening pumps 13 and 14 are connected into a series with each other, so that when running, both produce a liquid flow in the same direction. The centrifugal pumps allow a liquid flow through them, when they are in the free mode. This makes it possible that the force of the opening and closing can be conveniently adjusted. When a smaller force is needed, only one of the opening or closing pumps can be started. If more force is needed, both opening or closing pumps can be started.

The closing pumps 11 and 12 and opening pumps 13 and 14 are centrifugal pumps used with an electric motor. The function of the centrifugal motors is prior art as such, and is not described further here. The figures do not show the control device, such as a computer, which is arranged to control the opening mechanism 2, i.e. the pumps 11, 12, 13 and 14. The figures also do not show necessary electricity or data transfer means. Controlling doors with a computer or the like is prior art as such.

A so-called Hall sensor 18 is arranged in the top end of the axis pole of the door hinge. It monitors movement of the door 1 and is connected with data transfer means to the control device of the arrangement. The sensor 18 sends the signal it has produced from the movement of the door to the control device.

FIG. 1 shows above the door an approach switch 19, which recognizes movement of a possible user occurring near the door 1. The approach switch 19 is connected to the control device in order to transfer the signal produced from the detected movement of the user to the control device.

The invention can for example be used in the following manner. If the approach switch 19 detects movement of a user near the door 1, it sends a signal about this to the control device. A decision is made in the control device about the opening of the door, whereby the second pump 13 is started, which pump achieves retracting of the piston rod 4 of the hydraulic cylinder inside the hydraulic cylinder 2 and thus opening of the door 1. The Hall sensor 18 monitors the movement of the door and sends information about the position and/or movement of the door to the control device. When the door 1 is in the fully open position, a decision is made in the control device about the necessary procedure, i.e. the second pump 13 is stopped and the first pump 11 is started. Thus the protrusion of the piston rod 4 of the hydraulic cylinder out of the hydraulic cylinder and thus the closing of the door 1 is achieved. When the door is fully closed, the control device sends a signal to the door lock in order to lock it.

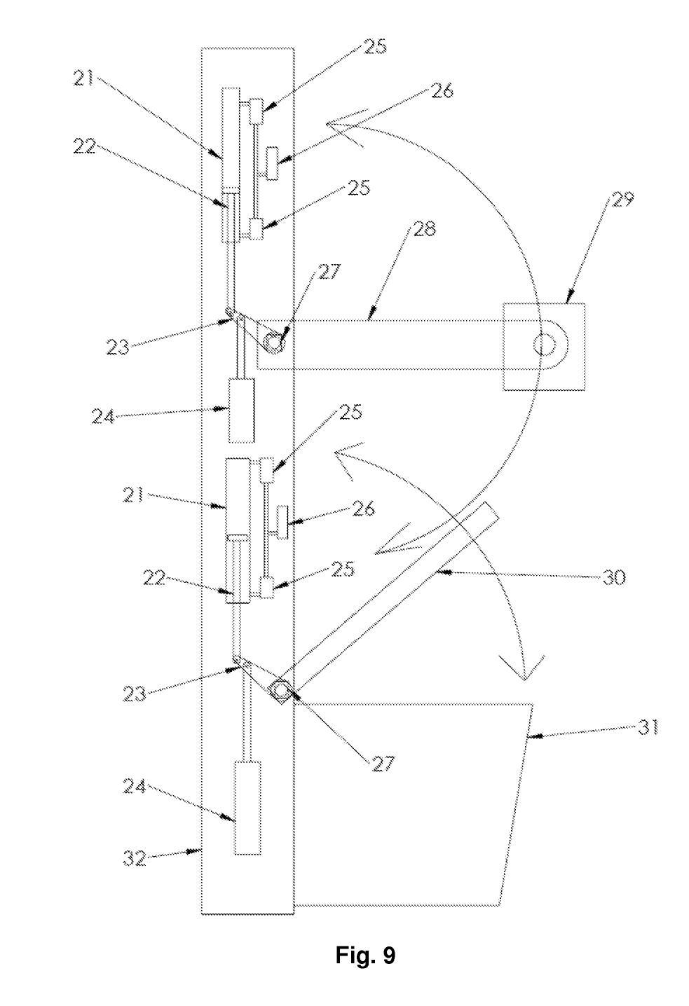

FIG. 9 shows the seat module of the automatic toilet according to the invention. The seat module frame comprises a backrest element 32. The toilet bowl 31 is attached to the bottom part of it. On top of the toilet bowl is a moveable seat 30, which is hinged to the backrest element. A washing device shaft 28 and the washing device 29 at the end of it is attached in a moveable manner via a hinge to the top part of the backrest element.

The movement of the washing device 29 and seat 30 is controlled with mutually identical transmission arrangements. The transmission arrangements mainly correspond to the ones presented in FIGS. 4-8 when it comes to their function, and all details of the arrangement are thus not shown in FIG. 9. The transmission arrangements in FIG. 9 comprise a hydraulic cylinder 21 and two centrifugal pumps 25 used with an electric motor. The first pump is connected via a liquid connection to the first side of the hydraulic cylinder 21 in order to achieve movement of the device in the first direction. The second pump is connected via a liquid connection to the second side of the hydraulic cylinder 21 in order to achieve movement of the device in the second direction. An expansion container 26 stores the hydraulic fluid. The invention further comprises a control device, such as a computer (not shown), with which the use of the pumps is controlled.

The piston rod 22 of the hydraulic cylinder moves a lever arm 23, which is attached via an axis to the moveable device, i.e. the seat 30 or shaft 28 of the washing device. A sensor 27, for example a Hall sensor, is attached to the hinge axis of both the seat 30 and the shaft 28 of the washing device. The sensor monitors the movement of the seat 30 and the shaft 28 of the washing device, and transfers the signal produced by the detected movement to the control device. A counterweight 24 has been attached to the lever arm 23. It is dimensioned to compensate for the weight of the seat and the washing device and its shaft. The counterweight produces a moment of approximately the same magnitude as the device moved around the axis. Thus moving the moveable device around the axis does not require great force. The counterweight can for example be dimensioned so that if the pumps 25 are not producing pressure, the moveable device stays in its place.

FIG. 9 does not show connections for water, detergent and drying air to be led into the washing device. The washing unit has nozzles, with which water and/or detergent and drying air is steered onto the seat, into the toilet bowl and/or onto another part of the toilet meant to be washed.

The arrangement in FIG. 9 can function for example in the following manner: When the automatic toilet is in use, i.e. not being washed, the shaft 28 of the washing device is in an upright position. Thus the washing device 29 or its shaft 28 does not impede the use of the toilet. The washing device 29 can for example be placed above the backrest element 32. When the washing program of the automatic toilet begins, the seat 30 is driven into a particular washing position, for example the approximately 45 degree angle shown in FIG. 9. The shaft 28 of the washing device is turned down and the washing device 29 washes the seat with the aid of the detergent and/or water spraying from its nozzles. The seat 30 can at some stage be lifted into an upright position, out of the way of the washing device.

The washing device can also wash the inner and/or outer surface of the toilet bowl 31 or other parts of the toilet, such as the floor. The seat and washing device can be controlled separately. The washing device 29 can have a drying air nozzle, with which the seat 30 or other parts can be dried. When the washing program is finished, the seat 30 is returned to the lower position and the shaft 28 of the washing device is lifted into the upright position.

It is not intended to limit the invention to the presented examples, but the scope is defined by the independent claims. The dependent claims present some preferred embodiments of the invention.

1. A transmission arrangement for moving a device, which transmission arrangement comprises:
a hydraulic cylinder, which can be connected to the moveable device in order to move it,
a first pump, which is connected via a liquid connection to a first side of the hydraulic cylinder in order to achieve movement of the device in a first direction,
a second pump, which is connected via a liquid connection to a second side of the hydraulic cylinder in order to achieve movement of the device in a second direction, and
a control device for using the first and/or second pump, wherein
the first and second pump are centrifugal pumps used with an electric motor, and wherein the transmission arrangement comprises
a sensor, for example a Hall sensor, which is arranged to monitor the movement and/or position of the device and connected to a control device in order to transfer a signal produced from the detected movement and/or position to the control device.

2. The transmission arrangement according to claim 1, wherein it comprises
a hydraulic fluid container, which is connected via a liquid connection to the hydraulic cylinder and the first pump and the second pump.

3. The transmission arrangement according to claim 1, wherein in said liquid connections are partly or completely made of plastic pipe.

4. The transmission arrangement according to claim 1, wherein the arrangement further comprises
an approach switch, which can be arranged to recognize movement of a user occurring near the device and which is connected to the control device in order to transfer a signal produced by the detected movement of the user to the control device.

5. The transmission arrangement according to claim 1, wherein the first pump, the second pump and the hydraulic cylinder are in the same closed fluid circulation together.

6. The transmission arrangement according to claim 2, wherein the suction connections of the first pump and second pump are connected to two branches of a T-joint and the third branch is connected to the hydraulic fluid container.

7. The transmission arrangement according to claim 1, wherein the outlet connections of the first pump and second pump are connected to the inlet connections of the hydraulic cylinder, on different sides of the hydraulic cylinder.

8. A door opening mechanism, which comprises a transmission arrangement according to claim 1 for achieving the closing movement and opening movement of the door.

9. A door, to which an opening mechanism according to claim 8 has been connected.

10. A moveable seat of an automatic toilet, wherein a transmission arrangement according to claim 1 has been arranged to move the seat.

11. A seat module of an automatic toilet, which comprises a frame and a toilet actuator attached to the frame to be moveable in relation thereto, wherein the seat module comprises a transmission arrangement according to claim 1, which is arranged to move the actuator.

12. The seat module according to claim 11, wherein the moveable actuator is a seat.

13. The seat module according to claim 11, wherein the moveable actuator is a washing device for the seat and/or toilet bowl.

14. An automatic toilet, wherein the toilet comprises
a door according to claim 9.

15. A method for using a device moved with a hydraulic cylinder, which method comprises at least the following steps
producing a signal for moving the device in a first or second direction and sending the signal to the control device,
if the signal was a signal to move the device in the first direction, a first pump is started by means of a signal from the control device, the pump producing fluid pressure on a first side of the hydraulic cylinder in order to move the device in the first direction,
if the signal was a signal to move the device in the second direction, a second pump is started by means of a signal from the control device, the pump producing fluid pressure on a second side of the hydraulic cylinder in order to move the device in the second direction,
whereby fluid pressure is produced with centrifugal pumps used with electric motors, wherein the method further comprises the following steps
monitoring the movement of the device with a sensor, for example a Hall sensor, which sends information to the control device about the position and/or movement of the device,
a decision is made in the control device about a necessary procedure,
starting or stopping, based on the made decision, the first pump and/or the second pump with the aid of a signal from the control device.

16. The method according to claim 15, wherein producing a fluid pressure of 0.1-2 bars.

17. The method according to claim 15, wherein
recognizing movement of a user occurring near the device with an approach switch, which sends a signal produced by the detected movement of the user to the control device,
a decision is made in the control device about a necessary procedure,
starting or stopping, based on the made decision, the first pump and/or the second pump with the aid of a signal from the control device.

18. The method according to claim 15, wherein
if the control device finds that the movement of the device has stopped in the middle of an expected movement, such as a door opening movement or closing movement, the first pump and/or the second pump is stopped.

19. The method according to claim 15, wherein
keeping the liquid to be pumped mainly pressure-free, when the first pump and the second pump are not pumping.

20. The method according to claim 15, wherein the moveable actuator is one or more of the following actuators of an automatic toilet:
a door;
a seat;
a washing device of a seat and/or toilet bowl.

21. An automatic toilet, wherein the toilet comprises a moveable seat according to claim 10.

22. An automatic toilet, wherein the toilet comprises a seat module according to claim 11.
